(19) United States
(12) Patent Application Publication
(10) Pub. No.: US 2021/0395069 A1
(43) Pub. Date: Dec. 23, 2021

(54) CONTACTLESS PRODUCT DISPENSER

(71) Applicant: Cepuder Steiner and Dohnalek LLC, Reno, NV (US)

(72) Inventor: Aaron E. Burda, Gilbert, AZ (US)

(21) Appl. No.: 17/319,485

(22) Filed: May 13, 2021

Related U.S. Application Data
(60) Provisional application No. 63/041,121, filed on Jun. 19, 2020.

(51) Int. Cl. B67D 1/08; B67D 1/16; B67D 1/12

(52) U.S. Cl. CPC B67D 1/0888; B67D 1/0801; B67D 1/124; B67D 1/16

(57) ABSTRACT

A dispenser system includes a support surface for a container, a motion sensor for sensing movement of the container with respect to the support surface, a dispenser for dispensing a product stream into the container, a display for displaying a plurality of product options, and a controller coupled with the dispenser, the display, and the motion sensor. The controller is configured to display the plurality of options via the display, receive an indication of movement of the container with respect to the support surface, associate the indication of movement with at least one selection made from the plurality of options on the display, update the display to indicate the at least one selection made from the plurality of options on the display, and dispense a customized product stream based upon the at least one selection made from the plurality of options on the display.

### CROSS-REFERENCE TO RELATED APPLICATIONS

The present application claims the benefit under 35 U.S.C. § 119(e) of U.S. Provisional Application Ser. No. 63/041,121, filed Jun. 19, 2020, and titled “CONTACTLESS BEVERAGE DISPENSER,” which is herein incorporated by reference in its entirety.

### BACKGROUND

Dispensers are machines designed to portion and release a specific amount of product upon request by a user. Dispensers may deliver the specific amount of product automatically or through mechanical means. Typically, dispensers contain fluids or granular materials.

### DRAWINGS

The Detailed Description is described with reference to the accompanying figures. The use of the same reference numbers in different instances in the description and the figures may indicate similar or identical items.

FIG. 1 is a perspective view illustrating a dispenser system including a container support, a dispenser and a display in accordance with example embodiments of the present disclosure.

FIG. 2 is a partial exploded perspective view of the dispenser system illustrated FIG. 1.

FIG. 3 is an exploded view illustrating a container support, such as the container support for the dispenser system illustrating in FIG. 2, in accordance with example embodiments of the present disclosure.

FIG. 4 is a selection display of a variety of beverage products available at the dispenser system in accordance with example embodiments of the present disclosure.

FIG. 5 is a selection display of a variety of beverage flavors available at the dispenser system in accordance with example embodiments of the present disclosure.

FIG. 6 is a perspective view of the dispenser system of FIG. 1 showing a container being rotated about a vertical axis for product selection in accordance with example embodiments of the present disclosure.

FIG. 7 is a perspective view of the dispenser system of FIG. 1 showing the container being moved or pressure being exerted on the container along a vertical axis for product selection in accordance with example embodiments of the present disclosure.

FIG. 8 is a cross-sectional side view of a container placed on top of a container support, such as the container support illustrated in FIG. 3, in accordance with example embodiments of the present disclosure.

FIG. 9 is schematic of the components forming a dispenser system, such as the dispenser system illustrated in FIG. 1, in accordance with example embodiments of the present disclosure.

### DETAILED DESCRIPTION

Global beverage companies have installed tens of thousands of touchscreen beverage dispensers into quick-serve restaurants, sit-down restaurants, convenience stores and gas stations around the globe. The primary value of these dispensers is the flexibility that they offer to the customer to choose from a broad selection of drinks without needing staff to attend to the dispense process. These touchscreen dispensers are for carbonated and non-carbonated soft drinks as well as coffee and occasionally alcoholic beverages such as beer.

Most of these dispensers are used in a self-serve fashion, wherein the customer makes payment and is then provided a cup to fill their own drink at the dispenser. Touch-based dispensers typically require each customer to touch the screen in order to dispense a beverage. The screens may be sanitized up to several times per hour by a staff member who sprays the screen with a sanitizing agent and then wipes the screen with a paper towel. In any given hour of operation, and particularly during peak periods such as lunch, there may be hundreds of customers touching the screen between sanitizations.

The users of touchscreen dispensers interact with the frequently touched screen to select and then dispense their drink and typically consume food products with their chosen beverage. These meals and/or snacks will often be consumed without the use of utensils, such as eating French fries with one's hands, a hamburger wrapped in a piece of wax paper or a candy bar.

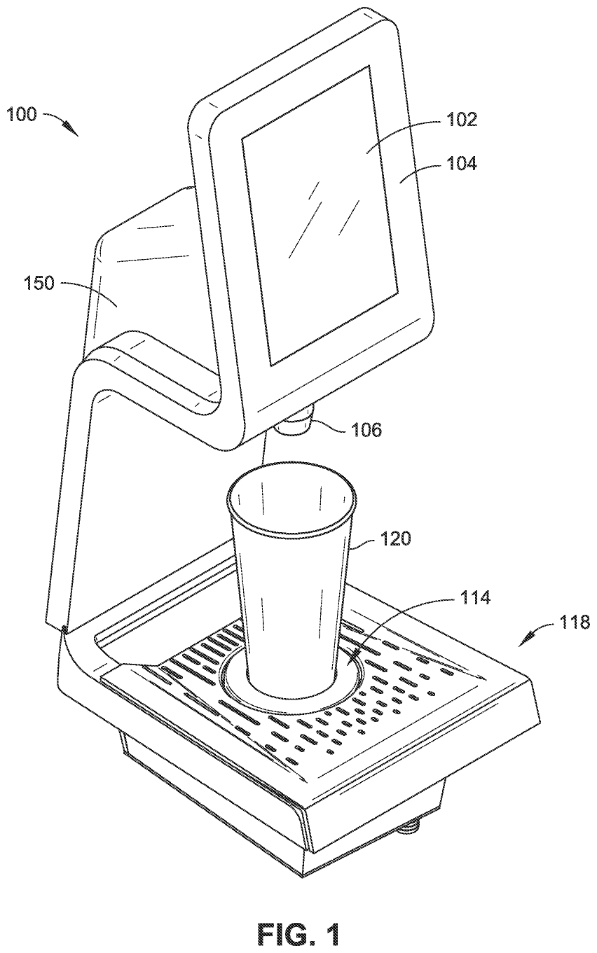

Referring generally to FIGS. 1 through 9, dispenser systems 100 are described that allow users to select and dispense a product of their choice (e.g., a beverage, etc.) without the need for the customer to come into physical contact with any part of the dispenser. The dispenser systems 100 can maintain the same or similar level of ease of use provided by an interactive touchscreen interface, do not necessarily require additional time for the customer to select and dispense a beverage, and can allow the user to easily modify a selection at the point of sale.

The dispenser systems 100 include a dispenser, a support surface for placement of a container, a motion sensor located on or in close proximity to the support surface for detecting the presence of the container, linear or rotational motion of the container with respect to the support surface, and detecting if the user has applied pressure to the support surface through the container. The dispenser system may include a proximity sensor to detect the proximity of the container to a point of dispense in the dispenser system.

With reference to FIGS. 1 through 9, a dispenser system 100 has a container support 114 for supporting a container 120 having at least one motion sensor for sensing movement of the container 120 with respect to the container support 114, and a dispenser 104 for dispensing a chosen product stream into the container 120 when the container 120 is at a support surface 110 of the container support 114. The dispenser system 100 also includes a display 102 for displaying a plurality of options to choose from associated with the product stream, and a controller 150 operatively coupled with the dispenser 104 and the display 102 and communicatively coupled with the motion sensor.

The controller 150 is configured to display the plurality of options via the display 102, receive an indication of movement of the container 120 with respect to the support surface 110, associate the indication of movement with at least one selection made from the plurality of options on the display 102, update the display 102 to indicate the at least one selection made from the plurality of options on the display 102, and dispense a customized chosen product based upon the at least one selection made from the plurality of options on the display 102.

The display 102 may display operation instructions to the user, a selection of product options to choose from, and/or other promotional material. The display 102 may be liquid crystal display (LCD) screen, a light-emitting diode (LED) screen, or any other type of electronic screen for displaying a graphical user interface (GUI). The display 102 may be on the dispenser 104, however, in embodiments of the dispenser system 100, the display 102 may not necessarily be an integral part of an existing dispenser 104. The display 102 may be retrofitted to existing dispensers 104 and communicate with the controller 150 via a wired and/or wireless connection.

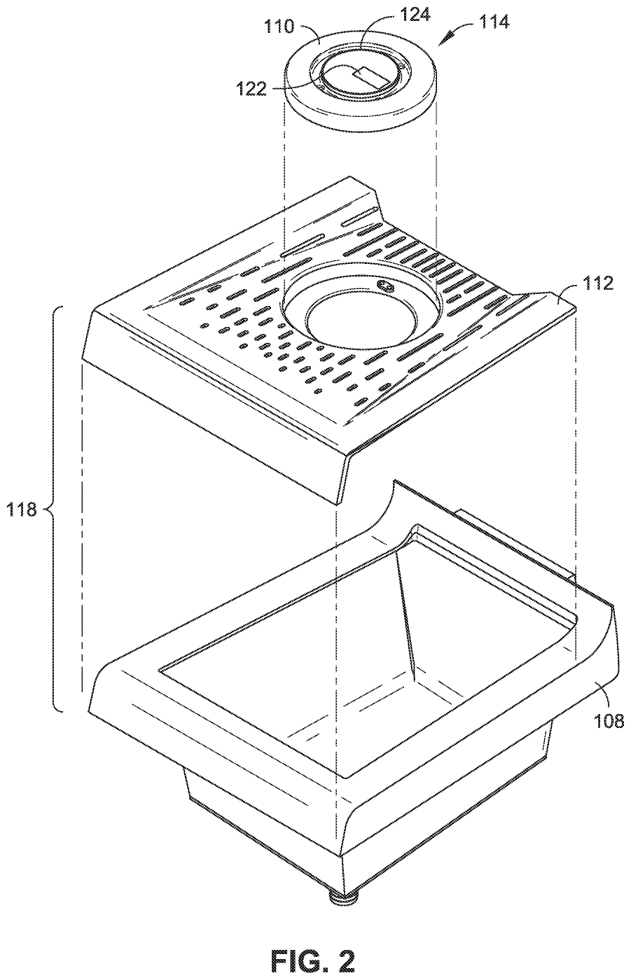

Referring now to FIG. 2, the container support 114 includes the support surface 110, and may include a drip tray 118. The support surface 110 may be a part of the drip tray 118 or may be removable from the drip tray 118. The example embodiment of the drip tray 118 includes a drip tray bottom container 108 and drip tray top plate 112 having a slanted top surface and drain holes for draining spilled and/or excess product dispensed by the dispenser 104. The material, size, angle, and shape of the drip tray 118 should not be considered limiting as embodiments of the support surface 110 or the container support 114 and may include variations from the example embodiment shown in FIG. 2.

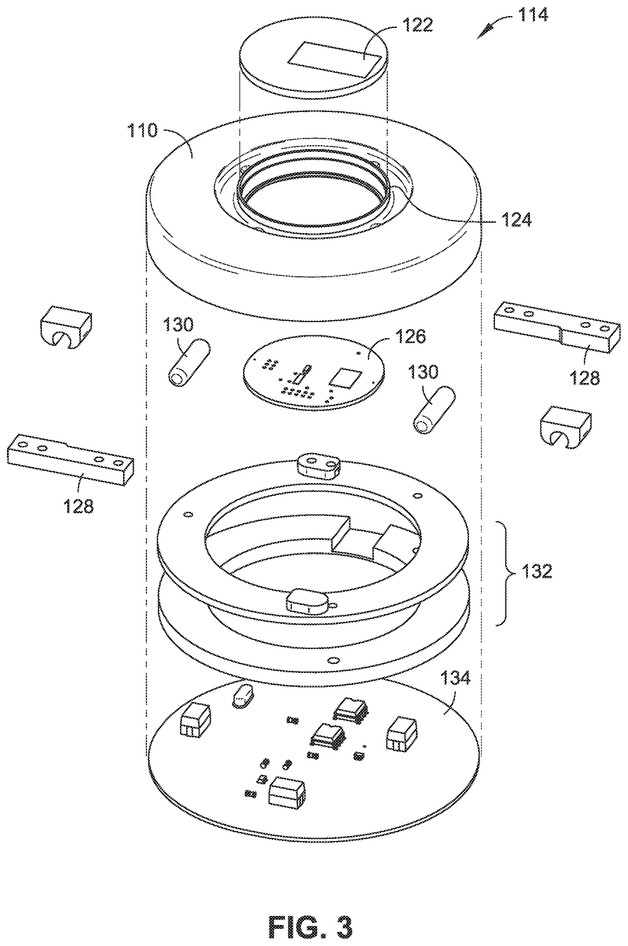

FIG. 3 shows an exploded view of an example embodiment of the container support 114. In some embodiments, the support surface 110 for supporting the container 120, may include a pedestal 124, where the pedestal 124 protrudes from the support surface 110. In embodiments of the disclosure, one or more motion sensors are disposed within the container support 114 to identify when the container is at the support surface 110. In embodiments, the at least one motion sensor may be in close proximity to the support surface 110, beneath a plane defined by the support surface 110, within a ring defined by the support surface 110 (e.g., above the plane, at the plane, below the plane, etc.), and so forth. In embodiments, the at least one motion sensor may identify when the container 120 is supported on the support surface 110, adjacent or in close proximity to the support surface 110 (e.g., hovering within a proximity range over the support surface, etc.), or lifted from the support surface 110 as indicated by a proximity sensor. It should be noted that while the pedestal 124 is described with some specificity herein, in other embodiments, the support surface 110 does not necessarily include a pedestal 124. For example, the support surface 110 may be flat across its support surface (e.g., for supporting a flat-bottomed container, such as a flat bottomed ceramic coffee glass, or another type of container with a flat bottom, such as a box). In other embodiments, the support surface 110 may have one or more depressions and/or indentations for nesting a container within the support surface 110.

In embodiments, the at least one motion sensor may be an optical sensor 126 having an optical lens 122 disposed within the pedestal 124 for sensing an indication of angular movement or rotational movement of the container 120 with respect to the support surface 110, a pressure sensor 128 (e.g., at least one load cell, etc.) for sensing an indication of downward movement of the container 120 with respect to the support surface 110 for the duration of time the downward movement is exerted, or any other type of motion sensors that detect whether the container 120 is present, whether the container 120 has leaned forward (away from the user), backward (towards the user), left, right, in a diagonal, or whether the container 120 has rotated in a clockwise or counterclockwise direction with respect to the support surface 110. Other examples of motion sensors include magnetic and/or mechanical sensors that detect the presence and the movement of the container 120. It should be noted that an indication of downward movement should not be limited to a perceptible visual movement of the container in relation to the support surface 110, and may include actual downward movement or any pressure exerted on the support surface

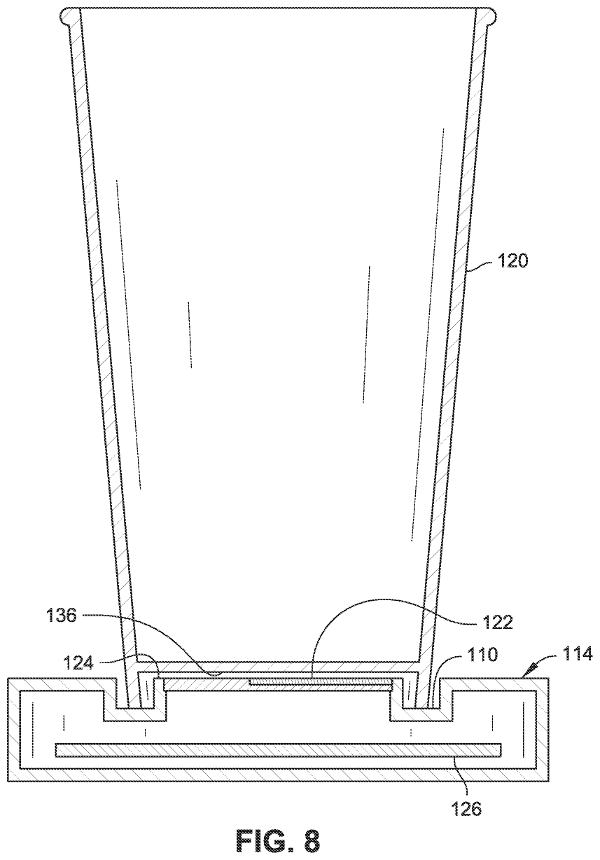

FIG. 8 shows a cross-sectional side view of the container support 114 supporting the container 120 in accordance with embodiments of the present disclosure. The container support 114 includes a pedestal 124 protruding from the support surface 110 that is in close proximity to a raised bottom surface 136 of the container 120. The optical sensor 126 faces the raised bottom surface 136 of the container 120, identifying the presence of the container 120 via the optical lens 122. The optical sensor 126 may include at least one optical transmitter, or light source, such as an LED light or an infrared light source. Embodiments of the optical transmitter may be positioned at a 45-degree angle with respect to the horizontal plane of the container support 114. However, embodiments of the optical sensor 126 may position the optical transmitter at a different angle. The optical lens 122 can maintain full optical functionality in a wet environment.

In some embodiments, the optical sensor 126 can be a “track on glass” type optical sensor, such as a track-on-glass sensor used in, for example, an optical mouse. In embodiments of the disclosure, this type of optical sensor, which is configured to detect when the optical sensor is in close proximity to a transparent and/or translucent surface, such as glass, can also detect a translucent surface such as wax paper (dry or wet) and/or other translucent or transparent materials from which a container may be constructed. In this example, other surfaces for which tracking is not desirable, such as an operator's hand, a drip of soda, and so forth, may be ignored by the track-on-glass sensor.

As described herein, the track-on-glass sensor can be an optical chip configured to transmit and detect infrared (IR) light (e.g., light from one or more lasers, light from one or more light emitting diodes (LEDs), etc.) at a wavelength of about eight hundred and fifty nanometers (850 nm). However, this wavelength is provided by way of example and is not meant to limit the present disclosure. In other embodiments, a track-on-glass optical sensor may transmit and/or receive other wavelengths greater than or less than eight hundred and fifty nanometers (850 nm). A track-on-glass optical sensor may also have motion detection interrupt output (e.g., where a signal is generated when a transparent and/or translucent surface is detected in proximity to the optical sensor 126). In some embodiments, multiple light transmitters and/or detection devices may be used (e.g., two (2) IR lasers, three (3) IR lasers, and so forth).

Referring again to FIG. 3, the container support 114 may further include a tactile feedback device 130, where the controller 150 is operatively coupled with the tactile feedback device 130 via a controller board 134 to provide feedback based upon the indication of movement of the container 120 with respect to the support surface 110. The tactile feedback device may be at least one haptic vibration motor or any other device that sends the user tactile information through touch, including force feedback, vibrotactile feedback, electrotactile feedback, ultrasound feedback, and thermal feedback. Through the tactile feedback device 130, the container support 114 may vibrate, for example, when the container support 114 is pressed or when the user rotates through one of the plurality of product options on the display 102. The tactile feedback device 130 may have a different vibration pattern or a different tactile feedback for different product selections and/or different movement directions of the container 120.

The container support 114 also includes one or more assembly brackets 132 encasing the optical sensor 126, the pressure sensor 128, the at least one tactile feedback device 130, and/or the controller board 134. The container support 114 can be a self-contained system and may be removable from the drip tray 118 for cleaning and maintenance. The container support 114 may be powered by a removable power source such as, but not limited to, a battery pack, rechargeable batteries, or may be powered by inductive power transfer when in contact with the drip tray 118 or another part of the dispenser 104. The container support 114, including the rechargeable battery pack, may be powered directly when installed on the drip tray 118 or on a different charging station if removed from the drip tray 118.

After determining a movement of the container 120 upon the support surface 110, the controller 150 updates the display 102 associated with dispensing the customizable product. The controller 150 associates the direction of the movement of the container 120 with at least one selection made from the plurality of options on the display 102 and updates the display 102 to indicate the at least one selection made from the plurality of options on the display 102. Finally, the dispenser 104 dispenses the customized product stream based upon the at least one selection made from the plurality of options on the display 102.

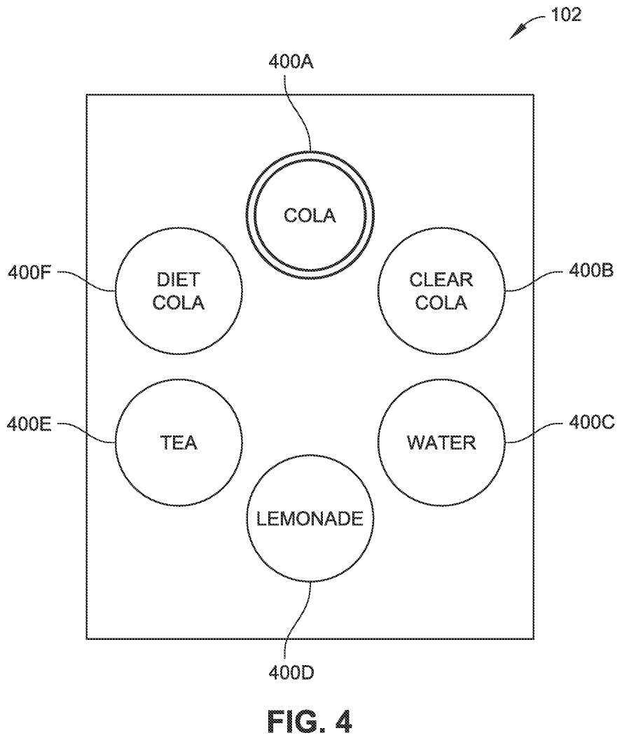

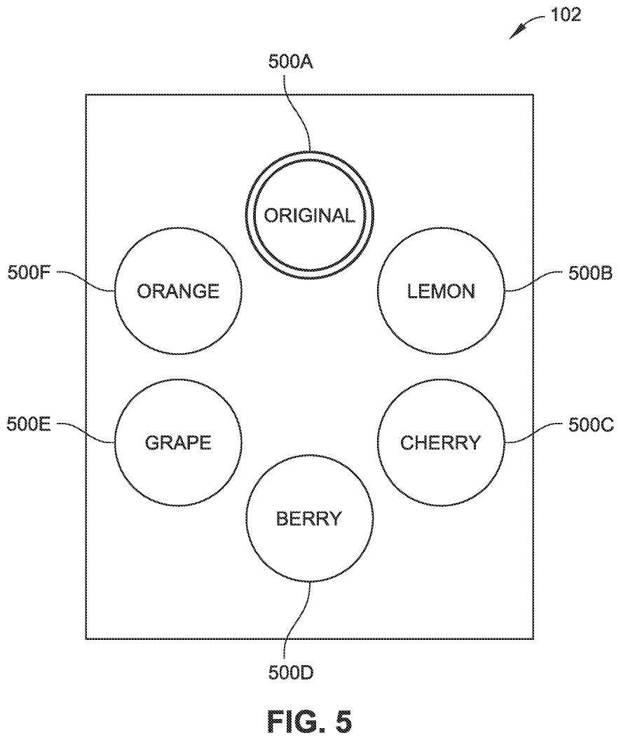

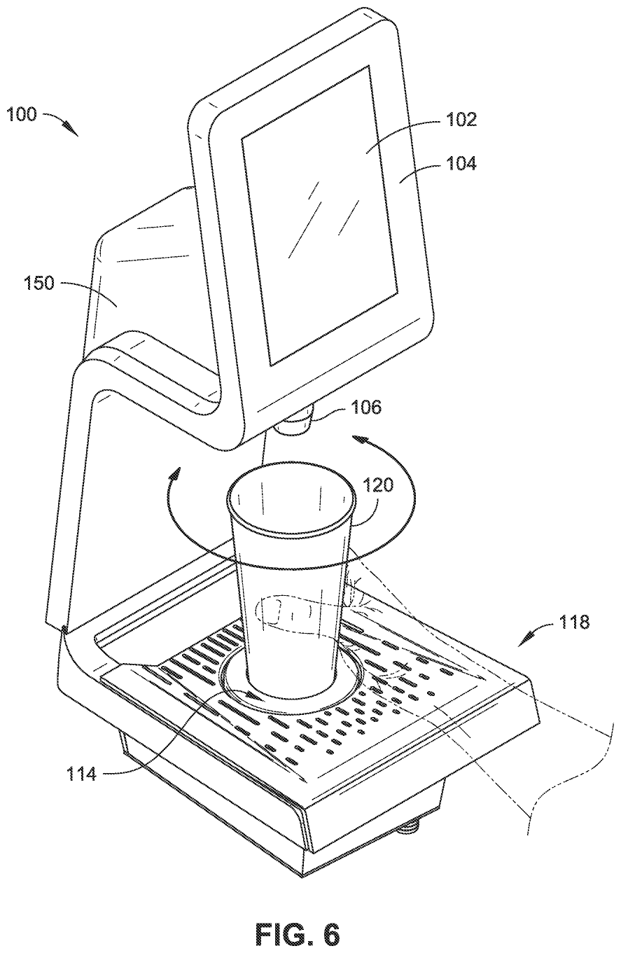

Referring to FIGS. 4 and 5, example screens of display 102 are shown. As the user places the container 120 on the support surface 110, instructions on the display 102 can instruct the user to rotate the container 120 to select the product, for example the beverage, of their choice. Display 102 shows a selector selecting through the available product options, such as a plurality of beverage options 400a through 400f, highlighting each available option sequentially based upon the detected rotation of the container in a given direction, either clockwise or counterclockwise, as shown in FIG. 6. It should be understood that the plurality of beverage options 400a through 400f are example options and a smaller or larger number of available options may be available for dispensing by dispenser system 100. Similarly, the dispenser system 100 may dispense other products other than beverages.

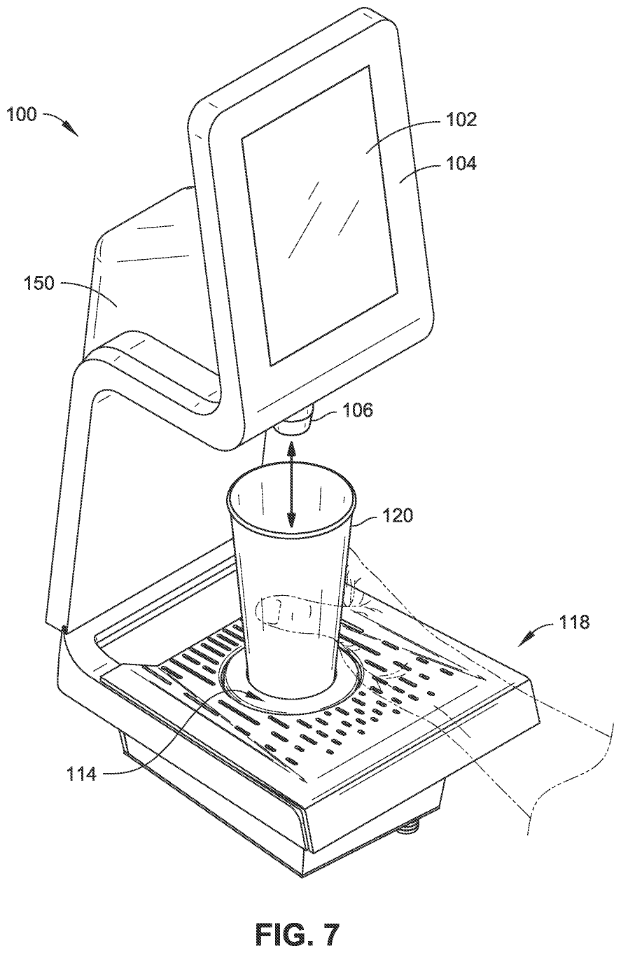

Display 102 may also present instructions for the user to press down the container for selecting the chosen product, as shown in FIG. 7. Once the user has selected their product of choice, additional product options to add to the container 120, such as a plurality of flavor additives 500a through 500f, and combinations thereof, are shown on display 102. The flavor additives may be selected by the user by rotating the container 120 clockwise or counterclockwise. It should be understood that the plurality of flavor additives 500a through 500f are example additional options and a smaller or larger number of available additional options may be available for dispensing by dispenser system 100. Similarly, the dispenser system may dispense other additional products other than flavor additives.

Display 102 presents the user an option to go back in the selection process, allowing the user to revert to the previous screen using the container rotation selection system and the container pressure detection. Once the consumer has selected their product of choice along with additional product options, if any is selected, an instruction to press and hold the container 120 against the support surface 110 is prompted to dispense the chosen product. The dispenser 104 may dispense the chosen product into the container 120 for the duration of the downward press, stopping the dispensing of the product if the pressure of the container 120 against the support surface 110 is lifted. The dispenser 104 may resume dispensing the chosen product if the pressure of the container 120 against the support surface 110 is resumed within a predetermined time frame. After the predetermined time frame has elapsed, the display 102 may revert to its default idle state.

Other forms of dispensing the necessary volume of chosen product may be implemented, such as including a digital scale on the support surface 110 to weigh the container 120 and stop dispensing the chosen product once a predetermined weight of the container 120 is reached, or dispensing a predetermined volume of product based on an identified size of the container 120 or a measured weight of the container 120 prior to dispensing. For example, the dispenser system 100 may weigh the container prior to dispensing the product and identify how much ice was added to the container 120 to determine the maximum volume of product to be dispensed that would not overflow the container 120. This example can include the use of a track-on-glass sensor as previously described. For instance, upon activation of a track-on-glass optical sensor 126, the container can be weighed to determine the available volume of the container (e.g., is a cup half full, does a cup have ice in it, etc.). Then, product can be dispensed based upon the detected weight of the container. The size of the container may be input by the user or identified by the optical sensor of dispenser system 100. The pressure sensor 128 or the digital scale may respectively send information about the possible force of the pressure exerted on the support surface 110 by the container 120 or the weight of the container 120 to the controller 150 via a digital or an analog signal.

In example embodiments when the temperature of the dispensed product is higher than room temperature, for example, hot beverages such as coffee, the display 102 may prompt the user to briefly press the container 120 against the container support 114 and remove their hand. The user does not necessarily need to hold the container 120 and apply a consistent pressure on the container support 114 of the support surface 110 throughout the duration of the product dispense.

In embodiments of the dispenser system 100, the dispenser 104 may include a proximity sensor disposed within or in close proximity of a container support 114 and/or a dispenser nozzle. In some embodiments, the proximity sensor may be a proximity sensor 106 disposed within or in close proximity to the dispenser nozzle. In other embodiments, the proximity sensor can be installed within or in close proximity to the container support 114. For example, the proximity sensor can be a component of (e.g., embedded in) and/or can be implemented using the optical sensor 126. Instead of and/or in addition to pressing and holding the container 120 against the support surface 110 to dispense the chosen product, the user may activate the dispenser 104 by briefly pressing, or clicking, the support surface 110 with the container 120 and raising the container 120 towards or away from the proximity sensor 106. The dispenser 104 may dispense the chosen product when the container 120 is within a predetermined proximity range of the proximity sensor 106 and stop dispensing the chosen product when the container 120 is removed from the dispense area near the proximity sensor 106 (e.g., out of range of the proximity sensor 126). Once the container 120 is removed beyond the predetermined proximity range of the proximity sensor 106, the dispenser 104 stops dispensing the chosen product. After a predetermined time has elapsed, the display 102 may revert to its default idle state. The proximity sensor 106 is communicatively coupled with the controller 150.

Embodiments of container 120 may include an anchor mark (not shown) located at the bottom of the container 120, facing the support surface 110. The position of the anchor mark in container 120 may be identified by the optical sensor 126, which may serve as an indication that the container has been moved or rotated with respect to the support surface 110 when the optical sensor 126 identifies a change in position of the anchor mark with respect to the support surface 110. Additionally, the anchor mark could be a QR code or a serial number identifiable by the optical sensor 126. The optical sensor 126 may read information relating to the container 120 such as volume, expected weight, among others. However, the anchor mark is not integral to the detection of rotation of the container 120 with respect to the support surface 110 and the optical sensor 126 may detect rotation of the container 120 without it.

The container 120 may have seams that are detectable by the optical sensor 126. The container 120 may be composed of paper, polystyrene or other types of polymers, glass, metals, resins, recycled fibers and/or other recycled materials. Additionally, the container 120 may have markers for robotic manufacturing.

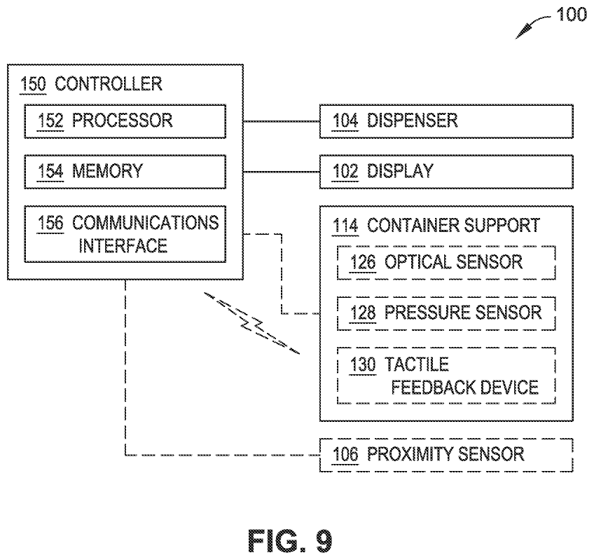

Referring now to FIG. 9, dispenser system 100, including some or all of its components, can operate under computer control. For example, a processor can be included with or in dispenser system 100 to control the components and functions of the dispenser system 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the system 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The dispenser system 100 can be coupled with a controller 150 for controlling the dispensing of the selected product. The controller 150 can include a processor 152, a memory 154, and a communications interface 156. The processor 152 provides processing functionality for the controller 150 and can include any number of processors, micro-controllers, or other processing systems, and resident or external memory for storing data and other information accessed or generated by the controller 150. The processor 152 can execute one or more software programs that implement techniques described herein. The processor 152 is not limited by the materials from which it is formed or the processing mechanisms employed therein and, as such, can be implemented via semiconductor(s) and/or transistors (e.g., using electronic integrated circuit (IC) components), and so forth. The controller 150 may be integrated directly into the dispenser 104 or be a separate component from the dispenser 104.

As shown in FIG. 9, the controller 150 communicates via a wired and/or wirelessly connection with the container support 114 and controls the signals received from the optical sensor 126, the pressure sensor 128, the tactile feedback device 130, and the proximity sensor 106. Additionally, the controller 150 receives and provides information to the display 102 and the dispenser 104.

The memory 154 is an example of tangible, computer-readable storage medium that provides storage functionality to store various data associated with operation of the memory 154 can store data, such as a program of instructions for operating the dispenser system 100 (including its components), and so forth. It should be noted that while a single memory 154 is described, a wide variety of types and combinations of memory (e.g., tangible, non-transitory memory) can be employed. The memory 154 can be integral with the processor 152, can comprise stand-alone memory, or can be a combination of both.

The memory 154 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the dispenser system 100 and/or the memory 154 can include removable integrated circuit card (ICC) memory, such as memory provided by a subscriber identity module (SIM) card, a universal subscriber identity module (USIM) card, a universal integrated circuit card (UICC), and so on.

The communications interface 156 is operatively configured to communicate with components of the dispenser system 100. For example, the communications interface 156 can be configured to transmit data for storage in the dispenser system 100, retrieve data from storage in the dispenser system 100, and so forth. The communications interface 156 is also communicatively coupled with the processor 152 to facilitate data transfer between components of the dispenser system 100 and the processor 152 (e.g., for communicating inputs to the processor 152 received from a device communicatively coupled with the controller 150). It should be noted that while the communications interface 156 is described as a component of a controller 150, one or more components of the communications interface 156 can be implemented as external components communicatively coupled to the dispenser system 100 via a wired and/or wireless connection. The dispenser system 100 can also comprise and/or connect to one or more input/output (I/O) devices (e.g., via the communications interface 156), including, but not necessarily limited to: a display, a mouse, a touchpad, a keyboard, and so on.

The communications interface 156 and/or the processor 152 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 156 can be configured to communicate with a single network or multiple networks across different access points.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

In the embodiment illustrated, the dispenser system 100 comprises a beverage dispenser. In embodiments, the beverage dispenser may dispense non-alcoholic beverages including but not limited to soft drinks, juices, coffee, and so forth, and alcoholic beverages including but not limited to beer, mixed alcoholic drinks, and so forth. The dispenser 104 typically uses a combination of pressurization equipment and valves (not shown) to control the dispense of the chosen product. However, those of skill in the art will understand that the dispenser system 100 is not necessarily limited to the beverage dispenser illustrated, and a variety of different products, fluid and non-fluid, may be dispensed by the dispenser system 100. For example, other products suitable to be dispensed by the dispenser system 100 can include but are not limited to edible products such as soft-serve ice creams, frozen yoghurt, soups or condiments, nuts, and candies, and non-edible products such as custom-colored paint, and so forth.

It is to be understood that the terms “user” and “customer” are used interchangeably herein to describe any who uses and/or operates the dispenser system 100.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A dispenser system comprising:
a support surface for supporting a container;
a motion sensor disposed within the support surface for sensing movement of the container with respect to the support surface;
a dispenser for dispensing a product stream into the container when the container is at the support surface;
a display for displaying a plurality of options, each one of the plurality of options associated with the product stream; and
a controller operatively coupled with the dispenser and the display and communicatively coupled with the motion sensor, the controller configured to:
display the plurality of options via the display,
receive an indication of movement of the container with respect to the support surface,
associate the indication of movement with at least one selection made from the plurality of options on the display,
update the display to indicate the at least one selection made from the plurality of options on the display, and
dispense a customized product stream based upon the at least one selection made from the plurality of options on the display.

2. The dispenser system as recited in claim 1, wherein the motion sensor comprises an optical sensor for sensing an indication of rotational movement of the container with respect to the support surface.

3. The dispenser system as recited in claim 1, wherein the motion sensor comprises a pressure sensor for sensing an indication of downward movement of the container with respect to the support surface.

4. The dispenser system as recited in claim 1, wherein the support surface comprises a drip tray.

5. The dispenser system as recited in claim 1, wherein the container comprises a beverage cup.

6. The dispenser system as recited in claim 1, further comprising a proximity sensor communicatively coupled with the controller for sensing a proximity of the container.

7. The dispenser system as recited in claim 6, wherein the controller is configured to dispense the customized product stream in response to the proximity of the container to the dispenser.

8. The dispenser system as recited in claim 1, further comprising a tactile feedback device, wherein the controller is operatively coupled with the tactile feedback device to provide feedback based upon the indication of movement of the container with respect to the support surface.

9. A container support comprising:
a support surface for supporting a container, the container having a raised bottom surface;
a pedestal protruding from the support surface;
an optical sensor disposed within the pedestal for sensing an indication of rotational movement of the container with respect to the support surface;

10. The container support as recited in claim 9, further comprising a pressure sensor for sensing an indication of downward movement of the container with respect to the support surface.

11. The container support as recited in claim 9, further comprising a drip tray.

12. The container support as recited in claim 9, wherein the container comprises a beverage cup.

13. The container support as recited in claim 9, further comprising a tactile feedback device.

14. A method for determining a movement of a container upon a support surface and updating a display associated with dispensing a customizable product stream, the method comprising:
supporting, upon a support surface, a container;
sensing, via a motion sensor, a movement of the container with respect to the support surface;
displaying, via a display, a plurality of options, each one of the plurality of options associated with a product stream to be dispensed into the container when the container is at the support surface;
associating the movement of the container with at least one selection made from the plurality of options on the display;
updating the display to indicate the at least one selection made from the plurality of options on the display; and
dispensing a customized product stream based upon the at least one selection made from the plurality of options on the display.

15. The method as recited in claim 14, wherein the motion sensor comprises an optical sensor for sensing an indication of rotational movement of the container with respect to the support surface.

16. The method as recited in claim 14, wherein the motion sensor comprises a pressure sensor for sensing an indication of downward movement of the container with respect to the support surface.

17. The method as recited in claim 14, wherein the support surface comprises a drip tray.

18. The method as recited in claim 14, further comprising sensing a proximity of the container.

19. The dispenser system as recited in claim 18, further comprising dispensing the customized product stream in response to the proximity of the container to the dispenser.

20. The method as recited in claim 14, further comprising providing tactile feedback based upon the movement of the container with respect to the support surface.
